(19) United States
(12) Patent Application Publication
(10) Pub. No.: US 2026/0216850 A1
(43) Pub. Date: Jul. 30, 2026

(54) SYSTEMS AND METHODS FOR HANDHELD PRESSES

(71) Applicant: Milwaukee Electric Tool Corporation, Brookfield, WI (US)

(72) Inventors: Seamus J.D. Herson, Brookfield, WI (US); Manas M. Mahaddalkar, Brookfield, WI (US); Bradford A. Gill, Brookfield, WI (US); Katherine R. Gaylord, Brookfield, WI (US); John S. Scott, Brookfield, WI (US); Eden M. Peterson, Brookfield, WI (US); Michael S. Van Dyke, Brookfield, WI (US)

(21) Appl. No.: 19/459,485

(22) Filed: Jan. 26, 2026

Related U.S. Application Data
(60) Provisional application No. 63/749,291, filed on Jan. 24, 2025.

(51) Int. Cl. B25B 27/02; F16C 43/02

(52) U.S. Cl. CPC B25B 27/023; F16C 43/02

(57) ABSTRACT

A power tool includes a housing defining a handle and a gearcase coupled to the handle. The gearcase defines a through opening in the housing. A ram is positioned in the through opening and movable relative to the housing along a ram axis. A drive nut is rotatably coupled to the housing to receive the ram so that rotation of the drive nut causes the ram to move along the ram axis. A motor is disposed within the housing, and a drive mechanism is coupled between the motor and the drive nut to transmit rotation of the motor to the drive nut.

### CROSS-REFERENCE TO RELATED APPLICATIONS

The present application is based on and claims priority to United States Provisional Patent Application 63/749,291, filed January 24, 2025, which is incorporated herein by reference in its entirety.

### FIELD

The present disclosure relates generally to presses. More particularly, the present disclosure relates to systems and methods for handheld presses.

### BACKGROUND

Presses are used in a variety of manufacturing and assembly operations to apply force to a workpiece. In automotive repair and assembly, presses are often used to install and remove press-fit components such as ball joints, bushings, and bearings. In general, presses include a moving ram to apply a force and a frame or other supporting member to resist the force of the ram. A workpiece is placed in the supporting member, and the ram contacts the workpiece to deform or move a portion of the workpiece. Larger presses with larger load capacity are often hydraulically driven, fly wheel driven, or servo driven to reliably generate the required force. Smaller presses with smaller load capacity, such as arbor presses or clamps, are often actuated by hand. These types of smaller hand-operated presses often include a lever arm or a gear reduction to increase the mechanical advantage of the user when operating the press.

### SUMMARY

Examples of the invention provide systems, tools, and methods associated with a handheld mechanical press.

In some aspects, a power tool can include a housing defining a handle and a gearcase coupled to the handle. The gearcase can define a through opening in the housing. A ram can be positioned in the through opening, the ram movable relative to the housing along a ram axis. A drive nut can be rotatably coupled to the housing. The drive nut can receive the ram so that rotation of the drive nut causes the ram to move along the ram axis. A motor can be disposed within the housing. A drive mechanism can be coupled between the motor and the drive nut to transmit rotation of the motor to the drive nut.

In some examples, the handle may extend along a handle axis that is parallel to the ram axis. In some examples, the motor may be positioned between the handle and the ram. In some examples, the motor may define a motor axis that is parallel to the handle axis. In some examples, the power tool may further include a frame that is coupled to the housing, the frame extending from the housing to engage a workpiece. In some examples, the drive nut may be a ball nut, and the ram may be a ball screw. In some examples, the drive mechanism may be an impact mechanism that includes an anvil to rotate with the drive nut, a hammer that rotates relative to the anvil to provide rotational impacts to the anvil, and a camshaft that rotates the hammer. In some examples, the hammer may include a first opening that receives the ram, the camshaft may include a second opening that receives the ram, and the anvil may include a third opening that receives the ram and the drive nut. In some examples, the power tool may further include a guide block that engages with the ram so that the ram is rotationally fixed relative to the housing. In some examples, the power tool may further include a trigger coupled to the handle and having a pull direction that is perpendicular to the ram axis.

In some aspects, a power tool can include a housing that defines a handle. A ram can extend through an output end of the housing, the output end opposite the handle. A working surface can be configured to contact a workpiece. The ram can be configured to move relative to the housing, along a ram axis, in response to a user input. The ram can be configured to transfer a force to the working surface via the workpiece based on motion of the ram when the workpiece contacts the working surface.

In some examples, the power tool may further include a first adapter positioned along the ram axis, and the working surface may be disposed on the first adapter. In some examples, the first adapter may define a cavity configured to receive at least a portion of the workpiece. In some examples, the cavity may be a through-hole, and the ram may be configured to extend through the cavity. In some examples, the first adapter may be coupled to the housing via a frame. In some examples, the power tool may further include a second adapter coupled to the ram. The second adapter may be configured to contact the workpiece, and the second adapter may be opposite the working surface relative to the workpiece. In some examples, the second adapter may be removably coupled to the ram, and the second adapter may be configured to couple to the ram at two or more axial locations of the ram. In some examples, the handle may define a handle axis, and the handle axis may be offset from the ram axis. In some examples, the handle axis may be substantially parallel to the ram axis. The power tool may further include an electric motor and a battery, and the electric motor may be configured to move the ram in response to the user input.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives, and descriptions thereof, will best be understood by reference to the following detailed description of one or more illustrative examples of the present disclosure when read in conjunction with the accompanying drawings.

FIG. 1 is a perspective view of a handheld press, according to an example embodiment.

FIG. 2 is an illustration of the handheld press of FIG. 1 performing a pressing operation.

FIG. 3 is an illustration of the handheld press of FIG. 1 performing a pulling operation.

FIG. 4 is a side elevation view of the press of FIG. 1 with a ram in a setup position.

FIG. 5 is a side elevation view of the press of FIG. 1 with the ram in a ready position.

FIG. 6 is a side elevation view of the press of FIG. 1 with the ram in a working position.

FIG. 7 is a diagrammatic view of the press of FIG. 1 including an impact drive system.

FIG. 8 is a diagrammatic view of a handheld press including a leadscrew drive system, according to an example embodiment.

### DETAILED DESCRIPTION

As briefly described above, presses are often used in manufacturing and assembly processes where a force must be applied to a workpiece for assembly or removal. However, known presses often compromise between having sufficient load capacity and maintaining portability, as higher load capacities often require larger frames and power supplies. Many larger presses require hydraulic pumps or high-voltage servos to achieve a desired load capacity. Thus, performing press operations often requires moving a workpiece to a large press that is remote from the work area, which causes delays and inefficiencies. In cases where the workpiece cannot be moved, use of larger and more powerful presses may not be feasible, particularly in limited space environments (e.g., within a wheel well of a vehicle). In assembly environments, a press is often made more portable by coupling the press to a robotic arm or other fixture capable of moving the press quickly, while an external power source is routed to the press. While suitable for assembly lines or other dedicated workspaces, such portable presses require significant setup time and infrastructure. Manually operated presses, such as arbor presses, bearing presses, or clamps, remove the need for external power sources but are limited by the input force that a user can provide. Some manually operated presses are paired with additional tools (e.g., drivers, impact drivers, nut runners, breaker bars, etc.) to increase output force or output speed, but these tools often have less-than-ideal shapes and ergonomics that make work in limited space environments difficult. Thus, there is a need for a portable press that can be brought to workpieces in limited space environments for assembly and repair operations, while being able to quickly apply greater loads than conventional manually operated presses.

The present disclosure provides a handheld, battery-operated press that is capable of generating high forces for assembly or removal operations without relying on a corresponding force input from a user. In some examples, the handheld press includes a ram with leadscrew threads that is driven by an impact-style electric motor. The electric motor drives an impacting mechanism that can generate greater torque output relative to its weight when compared to traditional electric motor transmissions. In this way, the handheld press can be moved and positioned more easily and with less strain on the user. Additionally, the ram of the handheld press is offset from a handle to make a setup length of the handheld press more compact. This configuration allows repair technicians to service a workpiece in a tight surrounding space without requiring the workpiece or surrounding components to be removed, which results in a significant time savings for routine repairs.

In some examples, the handheld press includes a removable frame to support a workpiece while the ram applies a compressive force to push against the workpiece to perform operations such as bearing insertion. In this way, the frame can be selectively attached to a tool body to allow for different types or sizes of frames to be used with the handheld press. In some examples, the handheld press includes a removable adapter to receive the workpiece and a removable adapter on the ram to apply a pulling force on the workpiece to perform operations such as bearing removal. The adapters are configured to be aligned with an axis of motion of the ram. Thus, when assembled, the handheld press, the frame, and the adapters are connected and pre-aligned, leading to easier setups and alignments. Additionally, a single handheld press can be used for multiple operations that may be required to replace damaged components such as ball joints.

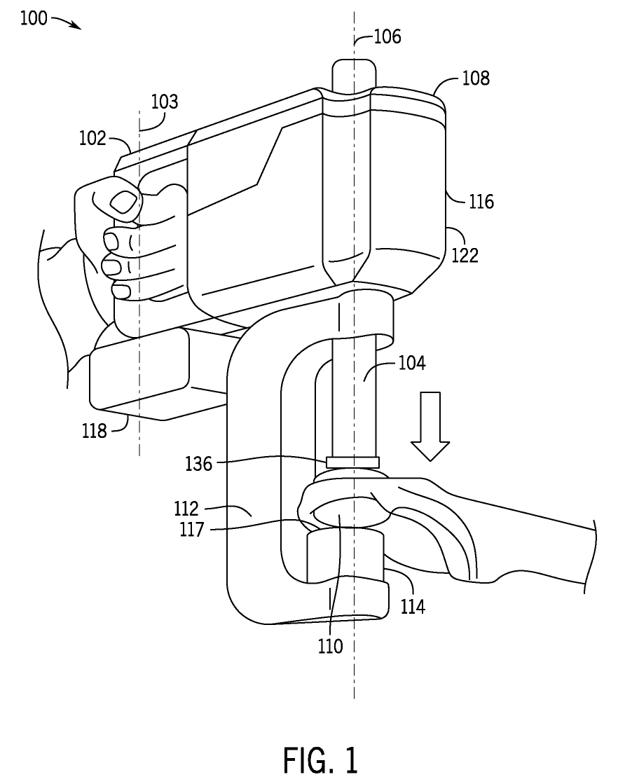

FIGS. 1-7 illustrate an example of a handheld press 100 (e.g., a power tool) according to the teachings of this disclosure. The handheld press 100 includes a tool body 116 and a frame 112 coupled to the tool body 116. The tool body 116 includes a housing 108 with a handle 102 and an output end 122 (e.g., a gearcase), with the handle 102 being opposite the output end 122. The output end 122 (e.g., the gearcase) defines a through opening in the housing 108 through which the ram 104 extends. The handle 102 defines a handle axis 103 and is configured to receive a hand of a user and support a weight of the handheld press 100. In some examples, the handle axis 103 is offset from the ram axis 106. In some examples, the handle 102 is coupled to the output end 122 at a first end and a second end of the handle 102. The handheld press 100 further includes an example ram 104 that moves along a longitudinal ram axis 106 through the output end 122 of the handheld press 100 (e.g., through an opening in the housing 108). In some examples, the ram axis 106 is substantially parallel to the handle axis 103. In other examples, the handle axis 103 can be substantially perpendicular or at another discrete angle relative to the ram axis 106 (e.g., about 15 degrees, about 20 degrees, about 30 degrees, etc.).

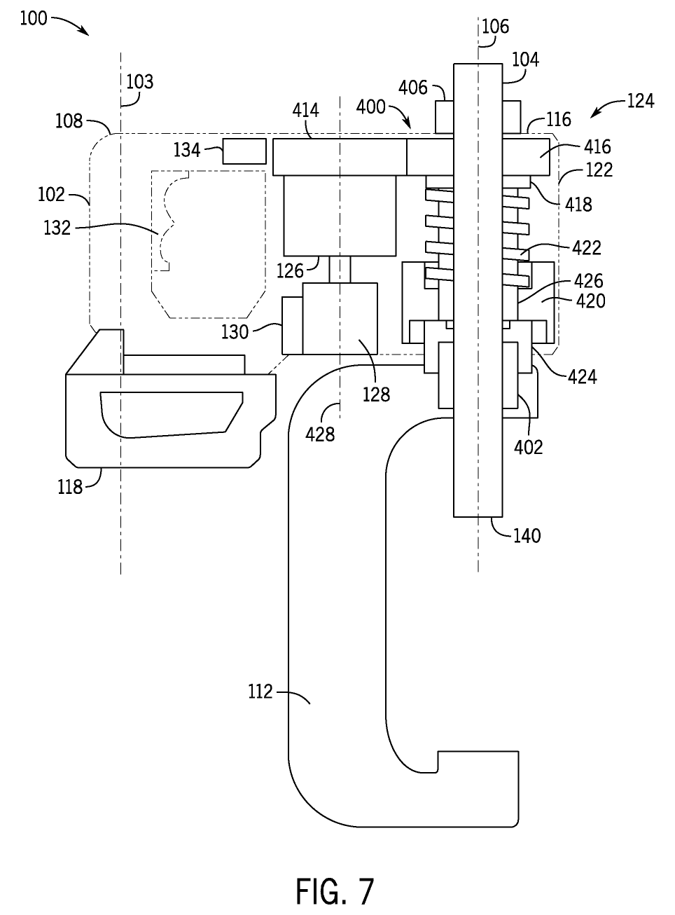

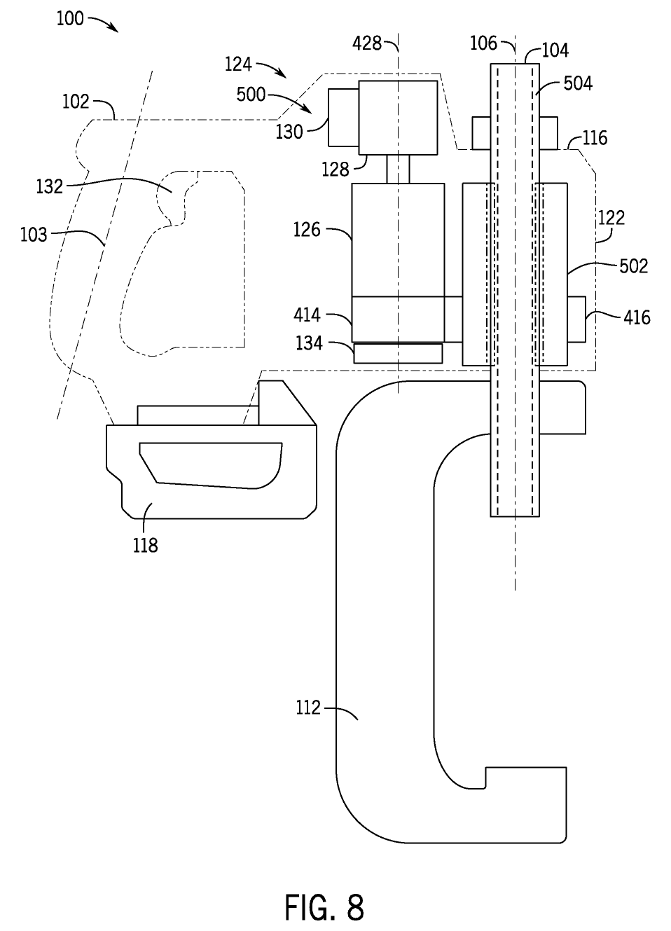

In some examples, the output end 122 includes a drive mechanism 124 that is attached to the housing 108 (e.g., is disposed within the housing 108) to translate the ram 104 along the ram axis 106, as shown in FIGS. 7 and 8. In this way, the ram 104 can apply a force to an example workpiece 110 positioned between the frame 112 and the ram 104. In some examples, the drive mechanism 124 includes a gearbox 126 that is driven by a motor 128. In some examples, the drive mechanism 124 includes a controller 130 that sends command signals to the motor 128 based on a user input received from a trigger 132 or a sensor 134. In some examples, the trigger 132 can have a pull direction that is perpendicular to the ram axis 106. In some examples, the handheld press 100 includes a battery 118 to provide power to the handheld press 100. In some examples, the battery 118 is received in a receptacle defined by the housing 108. In some examples, the battery 118 can be inserted into the receptacle along an insertion axis that is perpendicular to the handle axis 103. In some examples, the insertion axis of the battery 118 has a different angle relative to the handle axis 103 (e.g., parallel to the handle axis 103, at an acute angle relative to the handle axis 103). In other examples, the handheld press 100 includes an electrical cord that plugs into an outlet to provide power to the handheld press 100.

In some examples, the frame 112 includes a working surface 117 that receives the workpiece 110 and provides an opposing force to prevent the workpiece 110 from moving when the ram 104 applies a force to the workpiece 110. In some examples, the frame 112 includes a first adapter 114 (e.g., a first die) removably coupled to the frame 112, and the working surface 117 is disposed on the first adapter 114, opposite the frame 112. In some examples, the ram 104 includes a second adapter 136 (e.g., a second die) removably coupled to the ram 104 to contact the workpiece 110. In some examples, the second adapter 136 is shaped to interact with a portion of the workpiece 110. In this way, the ram 104 can selectively apply force to the workpiece 110 via the first adapter 114 and the second adapter 136 to perform a desired press operation (e.g., a pressing operation, a pulling operation).

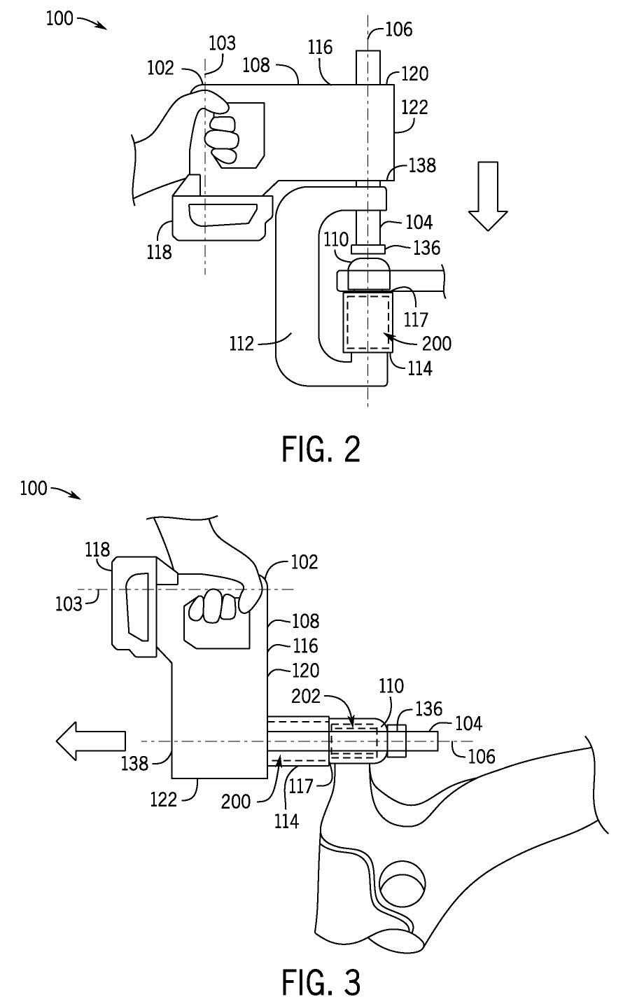

FIGS. 2 and 3 illustrate the handheld press 100 of FIG. 1 performing a removal operation according to aspects of the handheld press 100. Referring first to FIG. 2, the handheld press 100 is configured to apply a pressing force to the workpiece 110 to remove the workpiece 110 from another component or structure. In some examples, the workpiece 110 can be held by a hole or a collar in a base structure (e.g., a frame or other component of a vehicle). The first adapter 114 is coupled to the frame 112 opposite the ram 104 to receive the workpiece 110. The first adapter 114 contacts the workpiece 110 and may, in some examples, at least partially surround the workpiece 110 during the removal operation. In this way, the pressing force transferred by the ram 104 causes the workpiece 110 to move into a cavity 200 of the first adapter 114. In some examples, the cavity 200 facilitates centering the workpiece 110 near the ram axis 106. In some examples, the frame 112 is a c-frame removably coupled to the output end 122 of the tool body 116. In some examples, the frame 112 is coupled to a bottom side 138 of the output end 122 of the handheld press 100. In other examples, the frame 112 is coupled to a top side 120 of the output end 122, opposite the bottom side 138.

Referring now to FIG. 3, the handheld press 100 is configured to apply a pulling force to the workpiece 110 that moves the workpiece 110 toward the tool body 116. The ram 104 extends through and couples to the workpiece 110. In some cases, the workpiece 110 includes a through hole 202 that allows the ram 104 to be inserted through the workpiece 110. An example first adapter 114 is disposed between the output end 122 and the workpiece 110 to support the workpiece 110 when the pulling force is applied. The first adapter 114 is centered about the ram axis 106 to evenly contact the workpiece 110. An example second adapter 136 is threaded onto the ram 104 and sized to contact only the workpiece 110. In other examples, the second adapter 136 includes a hole to receive the ram 104 and couples to the ram 104 at a desired location (e.g., removably couples with a pin or key). In some examples, the second adapter 136 is configured to couple to the ram 104 at two or more axial locations of the ram 104. As the ram 104 is translated along the ram axis 106, the second adapter 136 contacts the workpiece 110 and causes the workpiece 110 to translate toward the first adapter 114. The force applied to the workpiece 110 by the ram 104 is supported by the working surface 117 of the first adapter 114, which causes the workpiece 110 to move. In some examples, the first adapter 114 defines the cavity 200 configured to receive the workpiece 110 during the removal operation and to align the workpiece 110 with the ram axis 106. In some examples, the first adapter 114 is coupled to the bottom side 138 of the output end 122 of the handheld press 100. In other examples, the first adapter 114 is coupled to the top side 120 of the output end 122, opposite the bottom side 138. The pulling operation advantageously allows the handheld press 100 to remove components where access to the components is limited, as only the ram 104 and the second adapter 136 extend past the workpiece 110. The pulling operation additionally allows the handheld press 100 to remove components where a total length of a component, a die, and a workpiece in a stacked configuration makes a pressing operation infeasible.

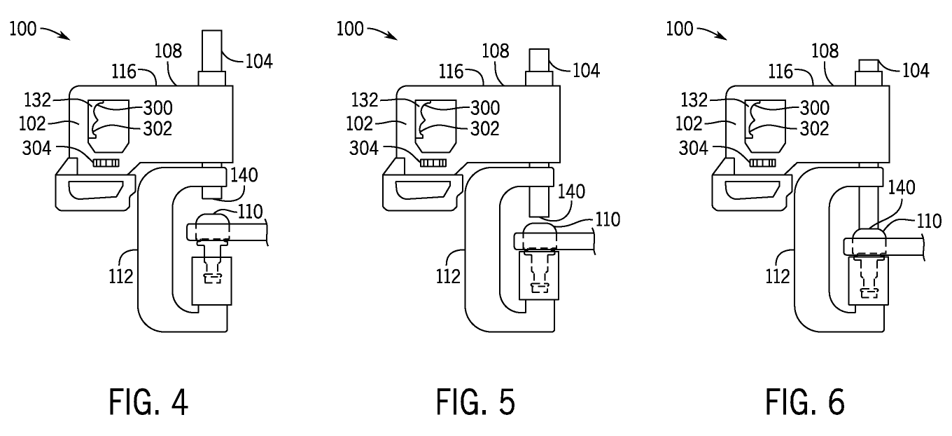

FIGS. 4-6 illustrate the handheld press 100 performing an example installation operation on an example workpiece 110. FIG. 4 shows the ram 104 in a setup position (e.g., a stored, initial, or first position) with a first end 140 of the ram 104 spaced apart from the workpiece 110. FIG. 5 shows the ram 104 in a ready position (e.g., a start, alignment, or second position) with the first end 140 of the ram 104 proximate the workpiece 110. FIG. 6 shows the ram 104 in a working position (e.g., an intermediate or third position) with the first end 140 of the ram 104 in contact with the workpiece 110 and the workpiece 110 fully installed. Further movement of the ram 104 to complete the press operation moves the ram 104 to an end position (e.g., a finish or fourth position).

During an initial setup of an operation, such as the installation operation of FIG. 4, the first end 140 of the ram 104 is moved to the setup position (e.g., close to the housing 108, or away from the housing 108 depending on whether the workpiece 110 is to be pulled or pressed) to make room for components and tooling that will be placed within the frame 112. Once setup is complete, the first end 140 of the ram 104 is moved to the ready position, as shown in FIG. 5, to make final adjustments before starting the operation. In some examples, the distance between the setup position of FIG. 4 and the ready position of FIG. 5 is a large portion of the total travel of the ram 104 (e.g., greater than 50 percent of the total travel). As such, the ram 104 is moved at or near a maximum translational speed when moving to the setup position or moving to the ready position to reduce a total time of the press operation. However, the movement of the ram 104 can be difficult to accurately stop when the ram 104 is moving at the maximum translational speed, which increases a risk of unwanted or damaging contact between the ram 104 and the workpiece 110.

In some examples, the trigger 132 is a multi-speed trigger that includes two user inputs. A first user input is provided when the user desires a high-speed, low-force movement (e.g., a jog movement) of the ram 104 for positioning. A second user input is provided when the user desires a low-speed, high-force movement. In some examples, the controller 130 limits a maximum current provided to the motor 128 in response to receiving the first user input and does not limit the maximum current in response to receiving the second user input. In some examples, the first user input and the second user input actuate the gearbox 126 to shift between a first gear ratio and a second gear ratio. In some examples, the first user input corresponds to a first deflection distance of the trigger 132 (e.g., a half press of the trigger 132), and the second user input corresponds to a second deflection distance of the trigger 132 (e.g., a full press of the trigger 132). In other examples, the first user input corresponds to a first actuation of the trigger 132 (e.g., a top half 300 of the trigger 132), and the second user input corresponds to a second actuation of the trigger 132 (e.g., a bottom half 302 of the trigger 132). In some examples, the first user input corresponds to a switch in a first position, and the second user input corresponds to the switch in a second position combined with a third user input (e.g., an actuation of the trigger 132). In some examples, the handheld press 100 includes an example speed input 304 (e.g., a speed dial) that receives a user input to set a maximum speed and/or a maximum force of the ram 104. In some examples, the controller 130 sets a maximum current provided to the motor 128 based on the speed input 304. By limiting the maximum speed and/or the maximum force of the ram 104 during rapid movements, the risk of damaging contact with the workpiece 110 during a setup operation is reduced.

In some cases, it can be advantageous for a handheld press to include an impact mechanism that can repeatedly provide impacts to a workpiece. Impact mechanisms can provide increased force and can also decouple the force application to reduce vibrations experienced by the user. For example, as shown in FIG. 7, the handheld press 100 includes a drive mechanism (e.g., the drive mechanism 124) configured as an impact drive system 400. The impact drive system 400 includes a drive nut 402 threadably coupled to the ram 104. In some examples, the drive nut 402 is a ball nut and the ram 104 includes ball screw threads. The drive nut 402 is coupled to the output end 122 of the tool body 116 to prevent the drive nut 402 from translating (e.g., along the ram axis 106). In response to the drive nut 402 rotating, the ram 104 translates along the ram axis 106. In some examples, the first end 140 of the ram 104 translates away from the housing 108 when the drive nut 402 rotates in a first rotational direction, and the first end 140 of the ram 104 translates toward the housing 108 when the drive nut 402 rotates in a second rotational direction opposite the first rotational direction (or vice versa). In some examples, the ram 104 is rotationally fixed by an example guide block 406 to cause the ram 104 to translate along the ram axis 106 in response to the rotation of the drive nut 402. In some examples, the ram 104 extends through the guide block 406 and a spline or keyway that receives a protrusion on the guide block 406 prevents rotation between the ram 104 and the guide block 406. In other examples, the ram 104 includes a flat surface extending along the ram axis 106 that engages with the guide block 406 to prevent rotation. In some examples, the guide block 406 is disposed outside of the housing 108. In other examples, the guide block 406 is disposed inside of the housing 108. In some examples, the guide block 406 is integrated into another structural component of the handheld press 100 (e.g., the tool body 116, the frame 112, the drive mechanism 124, the gearbox 126, etc.).

The impact drive system 400 is driven by the motor 128. In some examples, the controller 130 controls the motor 128 and monitors one or more sensors 134 within the handheld press 100. In some examples, the sensor 134 includes an encoder to detect rotation of the motor 128 or the drive mechanism 124. In some examples, the sensor 134 includes current sensors to detect a current going to the motor 128. In some examples, the controller 130 determines if the ram 104 has stopped translating based on data received from the sensor 134. In some examples, the controller 130 sends an instruction to the motor 128 to stop moving based on determining that the ram 104 has stopped translating.

In some examples, the gearbox 126 (e.g., a transmission) is arranged between the motor 128 and the drive nut 402 to transmit rotation of the motor 128 and cause corresponding rotation of the drive nut 402. For example, the gearbox 126 can be a speed-reducing gearbox that receives a torque input from the motor 128 and provides an increased output torque at a drive gear 414. In some examples, the gearbox 126 defines a transmission axis 428 (e.g., a motor axis). In some examples, the motor 128 and the drive gear 414 rotate about the transmission axis 428. In some examples, the transmission axis 428 is parallel to the ram axis 106. In some examples, the transmission axis 428 is parallel to the handle axis 103. In some examples, the transmission axis 428 is angled relative to the ram axis 106 or the handle axis 103.

In some examples, the drive gear 414 is coupled to a driven gear 416 that surrounds the ram 104 and rotates about the ram axis 106. The driven gear 416 is coupled to a camshaft 418. The camshaft 418 is hollow to allow the ram 104 to extend therethrough. The camshaft 418 is coupled to rotate with the driven gear 416 and extends from the driven gear 416 toward the drive nut 402. A hammer 420 surrounds the camshaft 418 and is biased by a spring 422 to contact an anvil 424. The driven gear 416, the camshaft 418, the hammer 420, and the anvil 424 are configured to rotate about the ram axis 106. In some examples, the hammer 420 includes an opening that receives the ram 104. In some examples, the camshaft 418 includes an opening that receives the ram 104. In some examples, the anvil 424 includes an opening that receives the ram 104.

The hammer 420 is coupled to the camshaft 418 via a cam surface 426. The cam surface 426 allows the hammer 420 to rotate between a first rotational position and a second rotational position relative to the camshaft 418 and causes corresponding translation along the ram axis 106 between a first axial position and a second axial position relative to the camshaft 418. The cam surface 426 controls the motion of the hammer 420 so that the hammer 420 is in the first axial position when in the first rotational position and is in the second axial position when in the second rotational position. The first axial position corresponds to the hammer 420 coupling to the anvil 424 to transfer torque to the anvil 424, and the second axial position corresponds to the hammer 420 decoupling from the anvil 424 to rotate freely relative to the anvil 424. The first rotational position corresponds to the anvil 424 coupling to the camshaft 418 via the cam surface 426 to transfer torque from the camshaft 418 to the anvil 424 while the transferred torque is below a threshold value. In other words, the hammer 420 is biased to be rotationally locked to the camshaft 418 but rotates relative to the camshaft 418 when the torque transferred to the hammer 420 exceeds the biasing force of the spring 422. Once the torque has passed the threshold value, the hammer 420 rotates about the ram axis 106 relative to the camshaft 418 in a first rotational direction toward the second rotational position. When the hammer 420 is in the second rotational position, the cam surface 426 of the camshaft 418 ends (e.g., terminates with a rigid surface) to prevent the hammer 420 from rotating further in the first rotational direction relative to the camshaft 418. Thus, the cam surface 426 fully transfers torque in the first rotational direction from the camshaft 418 to the hammer 420 when the hammer 420 is in the second rotational position. In other words, the spring 422 biases the hammer 420 toward the first rotational position and the first axial position when torque levels are low (e.g., below the threshold torque value), but the hammer 420 moves simultaneously toward the second rotational position and the second axial position when the torque levels exceed the threshold torque value. In this way, the hammer 420 couples to the anvil 424 when torques are at or below the threshold torque and decouples from the anvil 424 when torques are above the threshold torque.

Once decoupled from the anvil 424, the hammer 420 rotates relative to the anvil 424 until the hammer 420 returns to the first axial position via the biasing force of the spring 422. When the hammer 420 returns to the first axial position from the second axial position, the continued rotation of the hammer 420 causes the hammer 420 to impact the anvil 424, generating a torque impulse that is transmitted to the drive nut 402. Relatedly, when the hammer 420 decouples from the anvil 424, the torque transferred between the camshaft 418 and the hammer 420 drops below the threshold torque. Once below the threshold torque, the biasing force of the spring 422 causes the hammer 420 to rotate from the second rotational position relative to the camshaft 418 toward the first rotational position relative to the camshaft 418.

In some cases, impact can be provided when the motor 128 rotates in the first rotational direction or a second rotational direction so that impacts can be provided when pushing or pulling the ram 104. For example, when the motor 128 rotates in the second rotational direction, the hammer 420 moves simultaneously toward a third rotational position (e.g., a mirror of the second rotational position relative to the first rotational position) relative to the camshaft 418 and toward the second axial position when a torque in the second rotational direction exceeds the threshold value. When the hammer 420 is in the third rotational position, the camshaft 418 prevents further rotation of the hammer 420 in the second rotational direction relative to the camshaft 418. In this way, the impact drive system 400 functions similarly in the first rotational direction and the second rotational direction (e.g., in a clockwise direction and a counterclockwise direction).

The drive nut 402 of the impact drive system 400 is coupled to the anvil 424 to rotate about the ram axis 106. In some examples, the drive nut 402 is integral to the anvil 424. In some examples, the anvil 424 includes an opening that receives the drive nut 402 and the ram 104. As described above, the anvil 424 rotates with the camshaft 418 (e.g., the anvil 424 is coupled to the camshaft 418) when a reaction torque transferred from the anvil 424 to the hammer 420 is lower than the threshold value. For example, when the ram 104 is translating under low loads (e.g., not generating force on the workpiece 110), the drive nut 402 transfers little torque (e.g., below the torque threshold) to the hammer 420 via the anvil 424. However, when the ram 104 begins to apply force to a workpiece (e.g., the workpiece 110), the drive nut 402 transfers increasing torque to the hammer 420 via the anvil 424. When the torque transferred by the drive nut 402 exceeds the threshold value, the continued rotation of the camshaft 418 causes the hammer 420 to repeatedly impact (e.g., to strike, to provide rotational impacts to) the anvil 424 as the hammer 420 reciprocates between the first axial position and the second axial position. The kinetic energy of these impacts on the anvil 424, based on a mass and a rotational speed of the hammer 420, is converted into repeated pulses of torque that are applied to the drive nut 402. In this way, the impact drive system 400 outputs greater peak torque to the drive nut 402 than the drive gear 414 outputs to the driven gear 416. The impact drive system 400 enables the handheld press 100 to use a gearbox 126 that outputs lower torque at higher rotational speeds while generating similar torque outputs to heavier gearboxes that output higher torques at lower speeds. In this way, a total weight of the handheld press 100 is lowered to improve ease of use and reduce fatigue experienced by users.

In some cases, it can be advantageous for a handheld press to include a direct drive mechanism that can apply continuous force to a workpiece. For example, as shown in FIG. 8, the handheld press 100 includes a drive mechanism (e.g., the drive mechanism 124) configured as a direct drive system 500 to translate the ram 104. The direct drive system 500 includes a drive nut 502 that is rotated by the motor 128 via the gearbox 126, the drive gear 414, and the driven gear 416 to impart an axial load on the ram 104. The ram 104 includes threads 504 that are received by the drive nut 502. In some examples, the drive nut 502 is a ball nut and the threads 504 of the ram 104 are ball screw threads to reduce friction generated during loading of the ram 104. In this way, the motion of the ram 104 is smooth and easily controlled by the user. In other examples, the ram 104 includes different style threads 504 that correspond with the drive nut 502, such as machine threads, multiple lead threads, square threads, acme threads, or buttress threads, etc. In some examples, the drive nut 502 is a half nut configured to separate into two components to allow rapid translation of the ram 104. Installation applications that require partial insertion of a component into a workpiece benefit from the direct torque control of the direct drive system 500, which allows the user to make more precise movements of the ram 104 when compared to movements of the impact drive system 400 of the handheld press 100. Additionally, the direct drive system 500 reduces wear on the ram 104 and the drive nut 502, which increases the usable life span of the ram 104. In some examples, the drive nut 502 is disposed in the output end 122 of the tool body 116 opposite the handle 102. In some examples, the driven gear 416 surrounds the drive nut 502. In some examples, the driven gear 416 is coupled to a longitudinal end of the drive nut 502. In some examples, the driven gear 416 and the drive nut 502 surround the ram 104 to rotate about the ram axis 106. In some examples, the gearbox 126 is disposed between the drive nut 502 and the handle 102.

The foregoing discussion is presented to enable a person skilled in the art to make and use examples of the invention. Various modifications to the illustrated examples will be readily apparent to those skilled in the art, and the generic principles herein can be applied to other examples and applications without departing from examples of the invention. Thus, examples of the invention are not intended to be limited to examples shown, but are to be accorded the widest scope consistent with the principles and features disclosed herein. The foregoing detailed description is to be read with reference to the figures, in which like elements in different figures have like reference numerals. The figures, which are not necessarily to scale, depict selected examples and are not intended to limit the scope of examples of the invention. Skilled artisans will recognize the examples provided herein have many useful alternatives and fall within the scope of examples of the invention.

It is to be understood that the invention is not limited in its application to the details of construction and the arrangement of components set forth in the foregoing description or illustrated in the attached drawings. The invention is capable of other examples and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or using a single mold, without rivets, screws, other fasteners, or adhesive to hold separately formed pieces together is an integral (and integrally formed) element. In contrast, an element formed from multiple pieces that are separately formed initially then later connected together, is not an integral (or integrally formed) element.

Also as used herein, unless otherwise limited or defined, “substantially parallel” indicates a direction that is within ± 12 degrees of a reference direction (e.g., within ± 6 degrees or ± 3 degrees), inclusive. Similarly, unless otherwise limited or defined, “substantially perpendicular” similarly indicates a direction that is within ± 12 degrees of perpendicular a reference direction (e.g., within ± 6 degrees or ± 3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

The term “about,” as used herein, refers to variation in the numerical quantity that may occur, for example, through typical measuring and manufacturing procedures used for articles of footwear or other articles of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “near,” “about,” and “approximately” refer to a range of values ± 15% of the numeric value that the term precedes.

As also used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

Further, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

In general, examples of the handheld press described herein allow for a pressing operation to be performed by a handheld tool without external power sources.

Thus, examples of the disclosed invention can provide a system and method for installing or removing press fit components where space or infrastructure is too limited for conventional presses. The previous description of the disclosed examples is provided to enable any person skilled in the art to make or use the invention. Various modifications to these examples will be readily apparent to those skilled in the art, and the generic principles defined herein may be applied to other examples without departing from the spirit or scope of the invention. Thus, the invention is not intended to be limited to the examples shown herein but is to be accorded the widest scope consistent with the principles and novel features disclosed herein.

We claim:

1. A power tool, comprising:
a housing defining a handle and a gearcase coupled to the handle, the gearcase defining a through opening in the housing;
a ram positioned in the through opening and movable relative to the housing along a ram axis;
a drive nut rotatably coupled to the housing, the drive nut receiving the ram so that rotation of the drive nut causes the ram to move along the ram axis;
a motor disposed within the housing; and
a drive mechanism coupled between the motor and the drive nut to transmit rotation of the motor to the drive nut.

2. The power tool of claim 1, wherein the handle extends along a handle axis that is parallel to the ram axis.

3. The power tool of claim 2, wherein the motor is positioned between the handle and the ram.

4. The power tool of claim 2, wherein the motor defines a motor axis that is parallel to the handle axis.

5. The power tool of claim 1, further comprising a frame that is coupled to the housing, the frame extending from the housing to engage a workpiece.

6. The power tool of claim 1, wherein the drive nut is a ball nut and the ram includes ball screw threads.

7. The power tool of claim 1, wherein the drive mechanism is an impact mechanism that includes:
an anvil to rotate with the drive nut;
a hammer that rotates relative to the anvil to provide rotational impacts to the anvil; and
a camshaft that rotates the hammer.

8. The power tool of claim 7, wherein the hammer includes a first opening that receives the ram, the camshaft includes a second opening that receives the ram, and the anvil includes a third opening that receives the ram and the drive nut.

9. The power tool of claim 1, further comprising a guide block that engages with the ram so that the ram is rotationally fixed relative to the housing.

10. The power tool of claim 1, further comprising a trigger coupled to the handle and having a pull direction that is perpendicular to the ram axis.

11. A power tool, comprising:
a housing that defines a handle;
a ram extending through an output end of the housing, the output end opposite the handle; and
a working surface configured to contact a workpiece,
wherein the ram is configured to move relative to the housing, along a ram axis, in response to a user input,
wherein the ram is configured to transfer a force to the working surface via the workpiece based on motion of the ram when the workpiece contacts the working surface.

12. The power tool of claim 11, further comprising a first adapter positioned along the ram axis, wherein the working surface is disposed on the first adapter.

13. The power tool of claim 12, wherein the first adapter defines a cavity configured to receive at least a portion of the workpiece.

14. The power tool of claim 13, wherein the cavity is a through-hole and the ram is configured to extend through the cavity.

15. The power tool of claim 12, wherein the first adapter is coupled to the housing via a frame.

16. The power tool of claim 11, further comprising a second adapter coupled to the ram, wherein the second adapter is configured to contact the workpiece, and wherein the second adapter is opposite the working surface relative to the workpiece.

17. The power tool of claim 16, wherein the second adapter is removably coupled to the ram, the second adapter configured to couple to the ram at two or more axial locations of the ram.

18. The power tool of claim 11, wherein the handle defines a handle axis, the handle axis offset from the ram axis.

19. The power tool of claim 18, wherein the handle axis is substantially parallel to the ram axis.

20. The power tool of claim 11, further comprising an electric motor and a battery, wherein the electric motor is configured to move the ram in response to the user input.
